(19) United States
(12) Patent Application Publication
(10) Pub. No.: US 2006/0285080 A1
(43) Pub. Date: Dec. 21, 2006

(54) PROJECTOR AND PROJECTION METHOD

(75) Inventor: Toru KURIHARA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/423,940

(22) Filed: Jun. 13, 2006

(30) Foreign Application Priority Data
Jun. 16, 2005 (JP) 2005-176026

(51) Int. Cl. G03B 21/14

(52) U.S. Cl. 353/70

(57) ABSTRACT

A projector includes: a light-modulation device for modulating an illumination light according to a piece of image information; a projection optical system for protecting a modulated light resulting from the modulation by the light-modulation device as an image on a screen; a movable holder capable of holding the light-modulation device in a condition where the light-modulation device is tilted with respect to an optical axis; and a control-processing device which corrects a projected image formed in the light-modulation device based on a distance from the projection optical system to the screen and a tilt angle of the light-modulation device thereby to correct a trapezoidal distortion of an image projected on the screen when the light-modulation device is arranged in relation to the projection optical system and the screen so that a requirement of Scheimpflug rule is satisfied.

### BACKGROUND

1. Technical Field

The present invention relates to a projector which uses a liquid crystal display panel or some other light-modulation device to project a video image, and a projection method using the same.

2. Related Art

A projector is typically placed on a desk, and used to project an image on a screen vertically placed above the desk. In this case, the projector body is placed horizontally, and oblique projection is performed by lens shift to prevent trapezoidal distortion, focus blurring, etc.

However, in the case of using means of lens shift, the optical system of the projector is arranged so that the optical axis of a light valve thereof is displaced from the optical axis of a projection lens thereof. Hence, in order to achieve brightness equivalent to brightness in the case without doing the lens shift, it is necessary to make the diameter of the projection lens into sufficient size, which tends to increase the size of the projector body and a manufacturing cost thereof. The above tendency is remarkable particularly in the application where the projection length is made shorter and the application where the projector is placed in a place far below the screen.

Therefore, with a compact desktop projector and other projectors assumed to be used in the situation where the projection length is made shorter or the situation where the projector is placed at a position far below the screen, it has been common that “Tilt projection,” in which the projector body is tilted, is performed, and the trapezoidal distortion caused during this time is corrected by digital image processing (see JP-A-2003-283963 and JP-A-2003-78842).

Further, another projector includes: a first projection optical system which forms an intermediate image with a trapezoidal distortion; and a second projection optical system which removes the trapezoidal distortion of the intermediate image, and it is arranged so that moving lens elements included in the second projection optical system in a direction of the optical axis or changing an angle thereof enables focusing on anywhere on the whole plane of a projection screen and therefore it can prevent the occurrence of trapezoidal distortion (see JP-A-6-148566).

However, with a projector as described in the former case on the assumption that tilt projection is performed, making the projection length shorter or tilting the projector body greatly enlarges the difference in projection length between up and down side of an image plane. Thus, though a large depth of focus is required for a projection lens on one hand, the view angle has to be widened on the other hand. Therefore, it is difficult to obtain a projection lens which can meet both the requirements.

Further, with a projector as described in the latter case, it is required to move lens elements included in the projection lens in a direction of the optical axis or to change an angle thereof. This not only makes the projection lens or driving mechanism thereof larger but also makes the control mechanism more complicated, leading to an increase in the cost of the projector.

### SUMMARY

An advantage of some aspects of the invention is to provide a projector with a relatively compact and low-cost projection lens, which enables focusing on an entire surface of a projection screen and which can prevent the occurrence of trapezoidal distortion, and a protection method using the projector.

A projector of an aspect of the invention includes: (a) a light-modulation device for modulating an illumination light according to a piece of image information; (b) a projection optical system or projecting a modulated light resulting from the modulation by the light-modulation device as an image on a screen; (c) a movable holder capable of holding the light-modulation device in a condition where the light-modulation device is tilted with respect to an optical axis; and (d) a control-processing device which corrects a trapezoidal distortion of an image projected on the screen by correcting an image formed in the light-modulation device based on a distance from the projection optical system to the screen and a tilt angle of the light-modulation, device, when the light-modulation device is arranged in satisfying a requirement of Scheimflug rule to the projection optical system and the screen.

In the projector, the movable holder can hold the light-modulation device in a condition where the light-modulation device is tilted with respect to the optical axis and as such, the light-modulation device can be arranged in satisfying the requirement of Scheimpflug rule to the projection optical system and the screen. Therefore, an image projected on the screen can be focused on the respective locations on the screen. Further, in the case where the requirement of Scheimpflug rule is satisfied, the control-processing device carries out trapezoidal distortion of an image projected on the screen based on the distance from the projection optical system to the screen and the tilt angle of the light-modulation device and as such, the whole projection image can be focused and made sharper without using a particular projection optical system, and the occurrence of trapezoidal distortion of the projection image can be suppressed.

Also, according to a specific form in association to the invention or an aspect thereof, the projection optical system has a focusing ring for focus adjustment, and the control-processing device determines the distance to the screen based on an output from a distance sensor for detecting a piece of distance information concerning the focusing ring. In this case, the distance to the screen can be obtained somewhat precisely and readily. Consequently, an image with a little trapezoidal distortion can be projected somewhat easily.

In addition, according to another aspect of the invention, the projector further includes a tilt sensor for detecting a piece of information on the tilt angle of the light-modulation device, wherein the control-processing device gains a piece of information on a tilt condition of the screen with respect to the optical axis based on outputs from the tilt sensor and the distance sensor. In this case, the trapezoidal distortion of a projection image can be corrected based on a piece of information concerning the tilt condition of the screen with reliability.

Further, according to another aspect of the invention, the movable holder forces the light-modulation device to rotate around a center position thereof where the optical axis goes through the light-modulation device, and the control-processing device writes a piece of information for checking a focusing condition in the center position of the light-modulation device or in a nearby position thereof when adjusting a tilting amount of the light-modulation device. In this case, the projection image of the piece of information is projected on the screen and as such, and an image can be focused on the center position on the optical axis with reference to a projection image for checking a focusing condition like this, and the light-modulation device can be made to rotate while maintaining the in-focus condition in the center position on the optical axis. As a result, a whole projection image can be focused rapidly.

The projection method according to another aspect of the invention is a projection method, by which a light-modulation device modulates an illumination light according to a piece of image information thereby to attain a modulated light, and the modulated light is projected, as an image, on a screen by a projection optical system. The projection method includes the steps of: (a) arranging the light-modulation device in satisfying a requirement of Scheimpflug rule to the projection optical system and the screen, by holding the light-modulation device so as to form a predetermined tilt angle with respect to an optical axis; and (b) correcting a trapezoidal distortion of an image projected on the screen, by correcting an image formed in the light-modulation device based on a distance from the projection optical system to the screen and the tilt angle of the light-modulation device. The predetermined tilt angle here includes a no-tilt condition such that a normal line of the light-modulation device is in parallel with the optical axis. (i.e. the tilt angle is zero).

According to the above-described projection method, the light-modulation device can be arranged in satisfying the requirement of Scheimpflug rule to the projection optical system and the screen and as such, an image projected on the screen can be focused on the respective locations on the screen. Further, in the case where the requirement of Scheimpflug rule is satisfied, the trapezoidal distortion of an image projected on the screen is corrected based on the distance from the projection optical system to the screen and the tilt angle of the light-modulation device and as such, a projection image can be focused generally and easily without using a particular projection optical system and the occurrence of trapezoidal distortion of the projection image can be suppressed.

### BRIEF DESCRIPTION OF THE DRAWINGS

The invention will be described with reference to the accompanying drawings, wherein like numbers reference like elements.

FIG. 1 is a view of assistance in explaining a projector in association with the first embodiment.

FIG. 2 is a block diagram of assistance in explaining a circuit and the like built in the projector shown in FIG. 1.

FIG. 3 is a view of assistance in explaining how to use the projector shown in FIG. 1.

FIG. 4 is a view of assistance in schematically explaining the magnification of projection for the projector shown in FIG. 1.

FIG. 5 is a block diagram of assistance in partially explaining a projector in association with the second embodiment.

### DESCRIPTION OF EXEMPLARY EMBODIMENTS

### First Embodiment

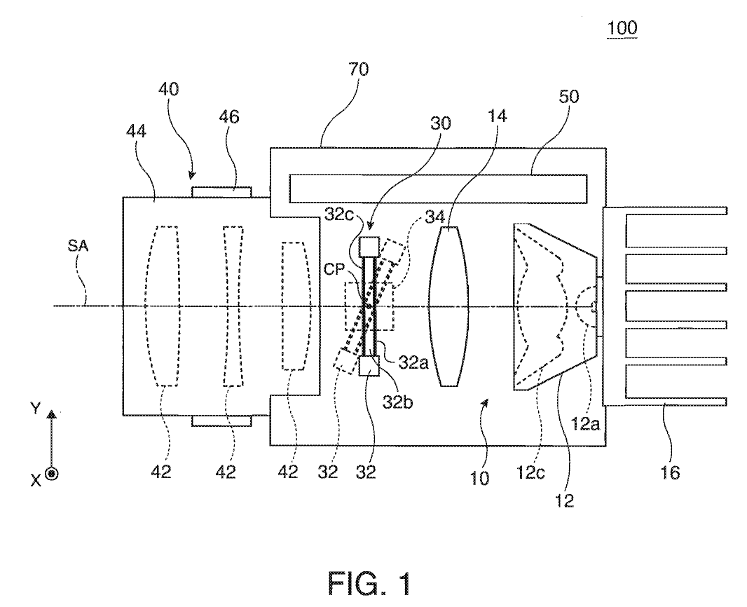

FIG. 1 is a exploded perspective view of assistance in explaining a structure of a projector in association with the first embodiment. The projector 100 in the embodiment includes: an illuminating device 10; a light-modulation device 30; a projection optical system 40; and a circuit unit 50. Of these constituents, optical elements constituting the illuminating device 10, the light-modulation device 30 and the projection optical system 40 respectively are positioned and housed in a housing part 70, which is a housing for optical parts and for which a predetermined system optical axis SA is set.

The illuminating device 10 is fixed so that it is embedded in the rectangular parallelepiped housing part 70, and includes: an illuminating unit 12 including a light-emitting source; an extension lens 14 for beam shaping; and a cooling fin 16 as a heat-dissipating device. Of these constituents, the illuminating unit 12 has: an LED light source 12a which creates a source light with an amount of light enough to meet the need for image light formation; and a light-uniformizing element 12c which uniformizes source light within the cross section of flux of light thereby to form an illumination light for the light-modulation device 30. The extension lens 14 is housed in the housing part 70 and fixed by a certain means (not shown). The extension lens 14 performs optical extension of the cross sectional shape of a beam of illumination light thereby to illuminate an illumination-target region of the light-modulation device 30 with efficiency. The cooling fin 16 performs air cooling thereby to dissipate the heat generated when source light is created in the illuminating unit 12.

The light-modulation device 30 is housed by and fixed in the housing part 70. The light-modulation device includes a liquid crystal light valve 32 and a rotation-driving device 34. The liquid crystal light valve 32 is a color-display, single-panel type light-modulation device. The liquid crystal light valve 32 uses a built-in polarizer 32a to restrict the direction of polarization of illumination light launched into it to a narrower range, and enhances the degree of polarization. Further, the liquid crystal light valve 32 regulates the condition of polarization of illumination light on a pixel-by-pixel basis according to a drive signal or image signal input to the built-in liquid crystal display panel 32b thereby to form a modulated light from the illumination light with its polarization degree enhanced by the above-described polarizer 32a. Still further, the liquid crystal light valve 32 has a built-in polarizer 32c, in which a polarization component In a particular direction is selected out of the modulated light obtained in the liquid crystal display panel 32b thereby to form image light.

The liquid crystal light valve 32 is supported by the rotation-driving device 34, and arranged so that it can rotate about e.g. X-axis extending perpendicularly to the system optical axis SA using the center position CT of its image-forming region as a fulcrum. The rotation-driving device 34 can hold the liquid crystal light valve 32 tilting the light valve by a desired angle with respect to the optical axis, which is to be described later. In other words, a normal line of the liquid crystal light valve 32 can be set to form a desired angle (including 0°) with respect to the optical axis. In this case, a tilt sensor (not shown) is used to monitor the tilt angle of the liquid crystal light valve 32.

The projection optical system 40 includes two or more lenses 42, and is partially housed and fixed in the housing part 70 by a lens barrel 44. The projection optical system 40 projects, as projected light, image light formed by the light-modulation device 30 onto a screen (not shown) with an appropriate magnification. Around the external circumference of the lens barrel 44 of the projection optical system 40, a focusing ring 46 is provided, which can be made to rotate along the side face of the lens barrel 44. When the focusing ring 46 is made to rotate appropriately, the one or more of the lenses 42 can be moved in the direction of the optical axis, whereby a focusing condition of an image projected on the screen can be adjusted. The focusing ring 46 has a distance sensor for detecting the amount of the rotation knot shown). Based on the output from the distance sensor, the distance from the projection optical system 40 to the screen can be detected as a piece of distance information.

The circuit unit 50 is intended to supply electric power to the illuminating device 10 and regulate the working condition of the light-modulation device 30. The circuit unit 50 includes a circuit board with a circuit pattern for wiring on a surface thereof, an IC mounted on the circuit board, and other electronic parts.

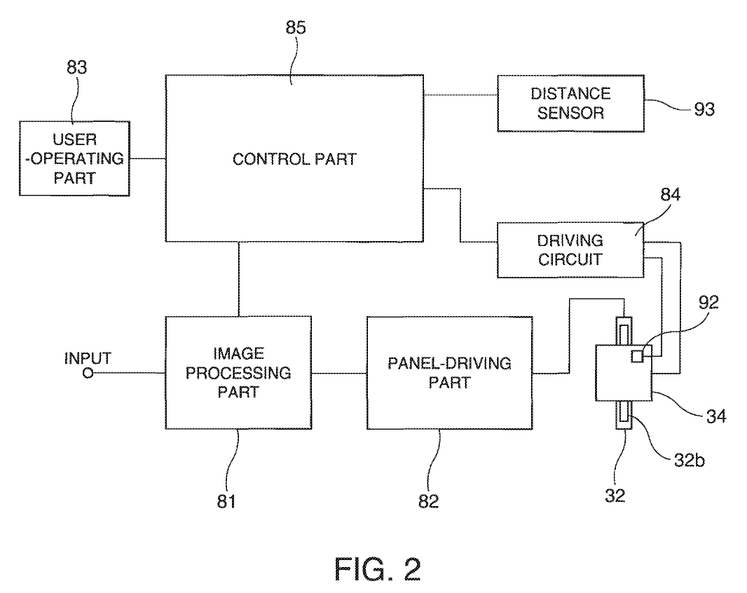

FIG. 2 is a block diagram of assistance in partially conceptualizing a circuit device built in the projector 100 shown in FIG. 1.

The circuit device includes: an image processing part 81 to which an external image signal such as a video signal is input; a panel-driving part 82 For driving the liquid crystal display panel 32b (also shown in FIG. 1); a user-operating part 83 which a user operates when the user enters his or her direction; a driving circuit 84 for forcing the rotation-driving device 34 (also shown in FIG. 1 to work; and a control part 85 for comprehensively controlling the operations of these constituents. In addition, the circuit device includes: a tilt sensor 92 for detecting a tilt angle of the liquid crystal light valve 32; and a distance sensor 93 for detecting a rotating position of the focusing ring 46 (shown FIG. 1). Of the these constituents, e.g. the image processing part 81, the panel-driving part 82, the driving circuit 84 and the control part 85 are incorporated in the circuit unit 50 (shown in FIG. 1)

The image processing part 81 is capable of correcting an image to be projected on a screen in its size and distortion or color balance thereof by carrying out an appropriate process on an image signal input from the outside thereof. Also, the image processing part 81 works based on a direction signal from the control part 35. For example, the image processing part 81 writes an image pattern (an image to be projected) resulting from trapezoidal transformation into an appropriate area in the image-forming region of the liquid crystal display panel 32b through the panel-driving part 82. Thus, even when the screen is inclined with respect to the projection optical system 40, an image with no distortion can be projected on a rectangular region on the screen. Also, the image processing part 81 is capable of projecting, as an image, additional information including a symbol and a character onto a screen instead of an image signal or superposing the additional information on the image signal. In other words, the image processing part 81 works based on a direction signal from the control part 85, and it performs, for example, an appropriate write operation on the liquid crystal display panel 32b through the panel-driving part 82 to display an operation setting and confirmatory menu of the projector 100, and various kinds of information concerning a working condition, etc. on a screen, and writes a focus mark for checking a focusing condition (a piece of information to be projected) in the center position CT of the liquid crystal display panel 32b or in a nearby position thereof to project a corresponding mark for checking a focusing condition onto the screen. The mark is utilized when the focusing ring 46 is used for focusing of the projection optical system 40.

The panel-driving part 82 generates a drive signal for adjusting the working condition of the liquid crystal display panel 32b based on an image signal processed in and output from the Image processing part 81. Thus, a desired video or picture image can be formed as a distribution of transmissivity corresponding to an image signal, etc. Input from the image processing part 81 in the liquid crystal light valve 32 which includes the liquid crystal display panel 32b and the polarizers 32a, 32c attached thereto.

The driving circuit 84 is capable of appropriately increasing and decreasing the tilt angle of the liquid crystal light valve 32 by outputting a control signal to the rotation-driving device 34. In addition, the driving circuit 84 monitors the tilt angle of the liquid crystal light valve 32 based on a detected signal from the tilt sensor 92 incorporated in the rotation-driving device 34.

The control part 85 is intended to comprehensively control operations of the projector 100. The control part regulates an image to be displayed on the liquid crystal display panel 32b through the image processing part 81. Also, the control part 85 can force the rotation-driving device 34 to work appropriately based on a direction from the user-operating part 83, and set the tilting posture of the liquid crystal light valve 32 so that the requirement of Scheimpflug rule is satisfied. In this case the tilt angle of the liquid crystal light valve 32 can be detected by the tilt sensor 92. Further, the control part 85 monitors the rotating position of the focusing ring 46 through the distance sensor 93 at all times, and therefore it is possible to detect the distance from the projection optical system 40 to the screen. That is, in the case where a user operates the focusing ring 46 to focus on an intersection point region thereof with the system optical axis SA on the screen, the distance from the projection optical system 40 to the intersection point region on the screen is calculated.

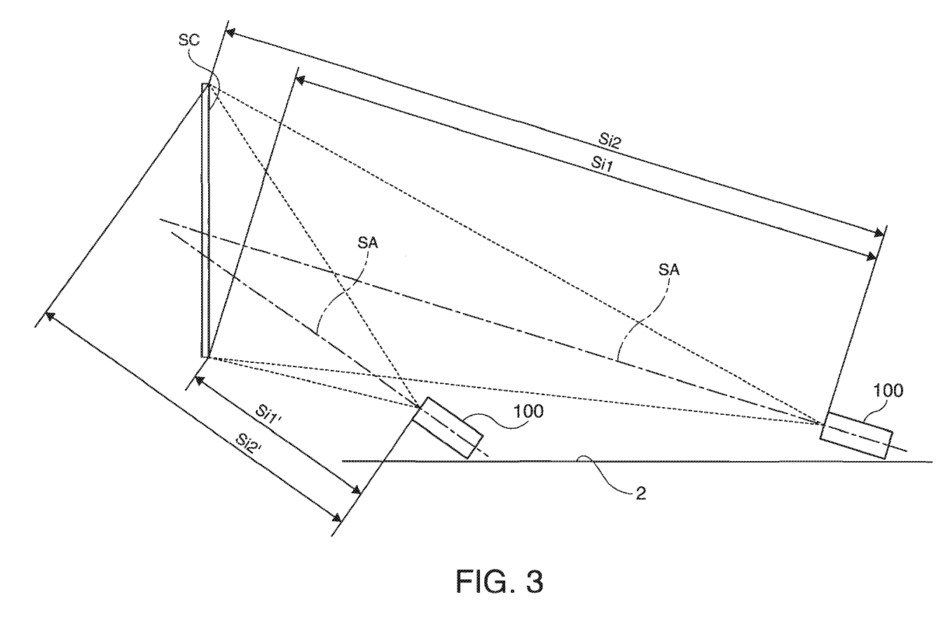

FIG. 3 is a view of assistance in explaining how to use the projector 100 in this embodiment. It is clear from the drawing that in the case of carrying out the projection onto a screen SC with the projector 100 placed on a stand 2, when the elevation angle of the projector 100 is small, the difference between the distance Si1 from the projector to the lower edge of the screen SC and the distance Si2 from the projector to the upper edge thereof is small, and therefore the required depth of focus is small. In contrast, it is obvious that when the elevation angle of the projector 100 is large, the difference between the distance Si1′ from the projector to the lower edge of the screen SC and the distance Si2′ from the projector to the upper edge of the screen SC is large, and therefore the required depth of focus is large. In other words, as for the projector 100 used under the condition where the elevation angle is large, it is difficult to use only the projection optical system 40 to increase the depth of focus. Therefore, it is desired that the projection optical system 40 and the liquid crystal light valve 32 of the projector 100 are arranged in relation to the screen SC so that the requirement of Scheimpflug rule is satisfied (the image-forming plane of the liquid crystal light valve 32, which is a subject, the lens principal plane of the projection optical system 40 and a plane of the screen SC as an image plane intersect in one place). When such requirement of Scheimpflug rule is satisfied, a projection image can be focused on an upper and lower portion of the screen SC regardless of the size of the depth of focus of the projection optical system 40.

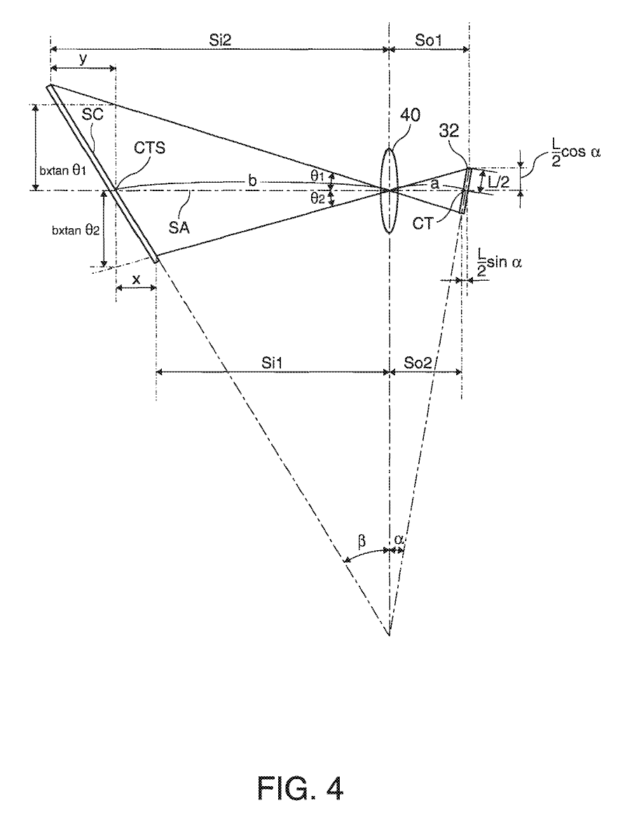

FIG. 4 is a view of assistance in schematically explaining the setting of the magnification of projection for the projector 100 in this embodiment. In the case of the projector 100, it is assumed that the requirement of Scheimpflug rule is satisfied in the relation between the projection optical system 40 and the screen SC by tilting the liquid crystal light valve 32 by the tilt angle α. Now, it is note that the tilt angle α has been known as a measured value of the tilt by the tilt sensor 92.

In the drawing, the angle β represents a tilt angle of the screen SC; the angle θ1 represents a divergence angle of the projection optical system 40 to the upper edge of the screen SC; the angle θ2 represents a divergence angle of the projection optical system 40 to the lower edge of the screen SC. Further, the symbol a represents the distance from the principal point (principal plane) of the projection optical system 40 to the center position CT of the liquid crystal light valve 32; the symbol b represents the distance from the principal point (principal plane) of the projection optical system 40 to the screen SC along the system optical axis SA. Of the symbols, the distance a is a known value which is determined when the projector 100 is designed. The distance b has been known from the conversion from a measured value obtained by the distance sensor 93. In addition, the symbol Si1 represents the distance from the principal point of the protection optical system 40 to the lower edge of the screen SC; the symbol Si2 represents the distance from the principal point of the projection optical system 40 to the upper edge of the screen SC; the symbol So1 represents the distance from the principal point of the projection optical system 40 to the upper edge of the liquid crystal light valve 32; and the symbol So2 represents the distance from the principal point of the projection optical system 40 to the lower edge of the liquid crystal light valve 32.

In this case, the magnification of projection M1 in the lower edge of an image projected on the screen and the magnification of projection M2 in the upper edge of the image are given by:
M1=Si1/So1 (1)
M2=Si2/So2 (2).
Hence, the ratio of upper side vs. lower side of the image projected on the screen SC is given by:
R=M2/M1=(Si1·So2)/(So1·Si2) (3).
By utilizing the ratio R, an image pattern to be formed in an image-forming region of the liquid crystal display panel 32b provided In the liquid crystal light valve 32 can be corrected. Specifically, by previously forming an image pattern, which has been subjected to the trapezoidal correction with a ratio resulting from reversal of the ratio R, in the liquid crystal display panel 32b, it becomes possible to project an image having no distortion in its rectangular profile onto the screen SC.

The distances Si1, Si2, So1 and So2 are given by:
Si1=b(1−tan β×tan θ2/(1+tan β×tan θ2))=b/(1+tan β×tan θ2),
Si2=b(1+tan β×tan θ1/(1−tan β×tan θ1)) b/(1−tan β×tan θ1,
So1=a+(L/2) sin α, and
So2=a−(L/2) s1n α,
where L is the lengthwise size of the liquid crystal light valve 32.

Incidentally, since Si1 is given by b−x and b×tan θ2=x/tan β+x tan θ2, Si1 is given as described above utilizing x=b×tan θ2×tan β/1+tan β×tan θ2). Likewise, Si2 is given by b+y, and therefore Si2 is given as described above utilizing y=b×tan θ1×tan β/(1−tan β×tan θ1).

In addition, in the above expressions, tan β=(b/a) tan α. Further, in the case of α=0, when the liquid crystal light valve 32 is not tilted, θ1=θ2=θ^{˜}=tan⁻¹(L/2a)′. Moreover, when it is assumed that spreading angles θ1 and θ2 of light at the upper and lower edges are reversed and maintained also on the side of the liquid crystal light valve 32, the following expressions are given.
tan θ1=tan θ0×cos α/(1−tan θ0×sin α)
tan θ2=tan θ0×cos α/(1+tan θ0×sin α)
However, as for the angles θ1 and θ2, the tilt angle α is small in general and as such, there is no problem even when an approximation such that θ1=θ2=θ^{˜} at all times is made.

The foregoing can be summarized as follows. The distances Si1, Si2, So1 and So2 can be determined when the tilt angle α obtained by the tilt sensor 92 and the distance b obtained by the distance sensor 93 are used as variables. Therefore, the ratio R of upper side vs. lower side of a projection image in the case of no correction is made can be determined. Thus, it becomes possible to readily determine the targeted amount of trapezoidal correction (upper side vs. lower side ratio)

Now, a method of using the projector 100 of the first embodiment will be described below. First, the projector 100 is placed on the stand 2 and arranged so that a whole projection image fits in the screen SC. Next, when a user operates the user-operating part 83, a direction is sent to the image processing part 81 through the control part 85. Then, a protected image composed of a focus-checking whole area pattern is formed in the whole liquid crystal light valve 32, and a projected image of a focus mark is formed in the center position CT so as to be superposed on the whole area pattern image. In other words, the focus-checking whole area pattern is projected on an entire surface of the screen SC, and the focus mark is projected on the position CTS on the screen SC where the system optical axis SA goes through the screen. When using the focusing ring 46 to adjust the focus of the projection optical system 40, the user uses the focus mark to check the focus. Subsequently, the user operates the user-operating part 83, whereby a direction is sent to the driving circuit 84 through the control part 85 and then the tilt angle of the liquid crystal light valve 32 is increased or decreased appropriately. The user can use the focus-checking whole area pattern projected on the entire surface of the screen SC and operates the user-operating part 83 to adjust the tilt angle of the liquid crystal light valve 32 so that a projection image on the screen SC is focused not only on the position CTS, but also on the upper and lower edges of the screen. In the condition where a projection image is thus in focus on the entire surface of the screen SC, the requirement of Scheimpflug rule is satisfied. The control part 85 calculates the ratio R based on the expression (3), and forms an image pattern subjected to trapezoidal correction with a ratio resulting from reversal of the ratio R in the liquid crystal display panel 32b, whereby an image having no distortion is projected on the screen SC.

The operations as described above can be repeated two or more times, therefore, the position of the focusing ring 46 and the tilt angle of the liquid crystal light valve 32 can be readjusted by continuing superposing the focus mark on the image pattern after the trapezoidal correction. This enables more accurate focusing and trapezoidal correction.

After the focusing and trapezoidal correction are terminated, the user operates the user-operating part 83 thereby to send a direction to the image processing part 81 through the control part 85, and then the focus-checking whole area pattern and the focus mark are erased from the projection image.

### Second Embodiment

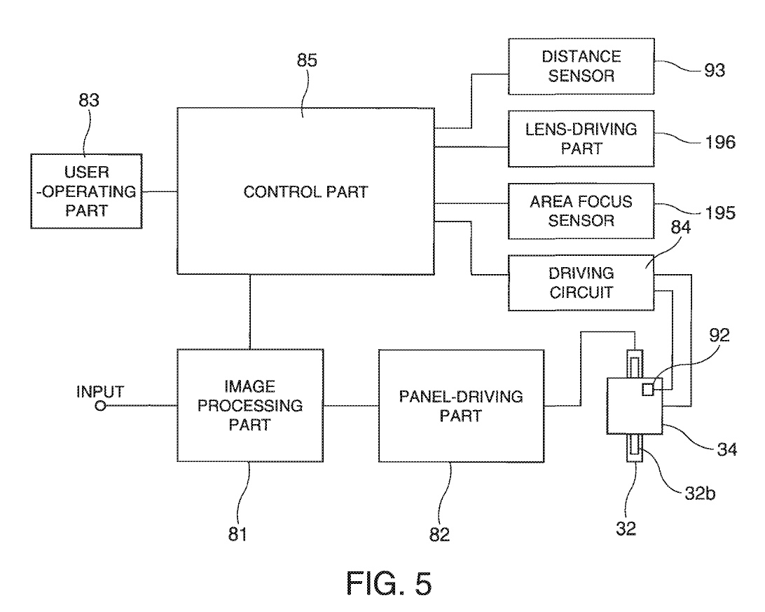

FIG. 5 is a block diagram of assistance in partially conceptualizing a projector in association with the second embodiment. The projector of the second embodiment is a modification of the projector of the first embodiment, and therefore common parts are identified by the same reference character, and repeated description thereof are omitted. Further, in a portion which is not described particularly, the projector of the second embodiment shall have the same structure as that of the projector of the first embodiment.

The circuit device included in the projector of the second embodiment further includes an area focus sensor 195 and a lens-driving part 196. The area focus sensor 195 is arranged so that it can detect an in focus condition in a center portion, an upper portion and a lower portion of an image projected on the screen SC. In addition, the lens-driving part 196 can force the focusing ring 46 to work by rote and automatically adjust the focus condition of the projection optical system 40.

The operations of the projector of the second embodiment will be described below. First, the projector 100 is placed on the stand 2 and arranged so that a whole projection image fits the screen SC. Next, when a user operates the user-operating part 83, a direction is sent to the control part 85. Then, the focus adjustment and trapezoidal correction are performed automatically. Specifically, the direction is sent to the image processing part 81 through the control part 85, a projected image having a focus-checking whole area pattern and a focus mark on and in the vicinity of the optical axis is formed (written) in the liquid crystal light valve 32, and then the whole area pattern and the focus mark are projected on the screen SC. With the focus mark, the control part 85 uses the area focus sensor 195 and forces the lens-driving part 196 to work appropriately, thereby to adjust the focus of the projection optical system 40. Subsequently, the control part 85 sends a direction to the driving circuit 84 thereby to appropriately increase and decrease the tilt angle of the liquid crystal light valve 32. In other words, as for the whole area pattern, the control part 85 uses the area focus sensor 195 and adjusts the tilt angle of the liquid crystal light valve 32 so that a projection image on the screen SC is in focus on the upper and lower edges of the screen. Thus, a projection image is focused on the entire surface of the screen SC and therefore the requirement of Scheimpflug rule is satisfied automatically. Finally, the control part 85 calculates the ratio R based on the expression (3), and forms an image pattern subjected to trapezoidal correction with a ratio resulting from reversal of the ratio R in the liquid crystal display panel 32b, whereby an image with no distortion is projected on the screen SC.

While the invention has been described based on the embodiments above, it is not limited to the embodiments. For example, in the embodiments, the rotation-driving device 34 forces the liquid crystal light valve 32 to rotate around X-axis using the center position CT as a fulcrum. However, the liquid crystal light valve 32 may be made to rotate about Y-axis. In this case, the principle is the same as that used in the former case, and the description of the detail is omitted. However, the focusing in the right and left direction and trapezoidal correction as well as the focusing in the up and down direction and trapezoidal correction are made possible.

In addition, the above liquid crystal light valve 32 was of a single-panel type. However, the liquid crystal light valve 32 may include e.g. red, blue and green liquid crystal light valves separately. Also, with a projector of a type such that individual color images formed in such color valves are combined, it is possible to perform trapezoidal correction of a projection image on the screen based on tilt angles of the liquid crystal light valves and the distance from the projection optical system to the screen while adjusting the tilting amounts of the liquid crystal light valves to meet the requirement of Scheimpflug rule.

The liquid crystal light valve 32 may be replaced with a reflection type tilt mirror device. Also, in this case, trapezoidal correction of a projection image on the screen can be performed based on the tilt angle of the tilt mirror device and the distance from the projection optical system to the screen while generally adjusting the tilting amount of the tilt mirror device to meet the requirement of Scheimpflug rule.

The entire disclosure of Japanese Patent Application No. 2005-176026, filed Jun. 16, 2005 is expressly incorporated by reference herein.

What is claimed is:

1. A projector comprising:
a light-modulation device for modulating an illumination light according to a piece of image information;
a projection optical system for projecting a modulated light resulting from the modulation by the light-modulation device as an image on a screen;
a movable holder capable of holding the light-modulation device in a condition where the light-modulation device is tilted with respect to an optical axis; and
a control-processing device which corrects a trapezoidal distortion of an image projected on the screen by correcting an image formed in the light-modulation device based on a distance from the projection optical system to the screen and a tilt angle of the light-modulation device, when the light-modulation device is arranged in satisfying a requirement of Scheimpflug rule to the projection optical system and the screen.

2. The projector of claim 1, wherein the projection optical system has a focusing ring for focus adjustment, and
the control-processing device determines the distance to the screen based on an output from a distance sensor for detecting a piece of distance information concerning the focusing ring.

3. The projector of claim 2, further comprising a tilt sensor for detecting a piece of information on the tilt angle of the light-modulation device,
wherein the control-processing device gains a piece of information on a tilt condition of the screen with respect to the optical axis based on outputs from the tilt sensor and the distance sensor.

4. The projector of claim 1, wherein the movable holder forces the light-modulation device to rotate around a center position thereof where the optical axis goes through the light-modulation device, and
the control-processing device writes a piece of information for checking a focusing condition in the center position of the light-modulation device or in a nearby position thereof when adjusting a tilting amount of the light-modulation device.

5. A projection method, by which a light-modulation device modulates an illumination light according to a piece of image information thereby to attain a modulated light, and the modulated light is projected, as an image, on a screen by a projection optical system, comprising the steps of:
arranging the light-modulation device in satisfying a requirement of Scheimpflug rule to the projection optical system and the screen, by holding the light-modulation device so as to form a predetermined tilt angle with respect to an optical axis; and
correcting a trapezoidal distortion of an image projected on the screen, by correcting an image formed in the light-modulation device based on a distance from the projection optical system to the screen and the tilt angle of the light-modulation device.
